(19) United States
(12) Patent Application Publication
(10) Pub. No.: US 2023/0386362 A1
(43) Pub. Date: Nov. 30, 2023

(54) Alternative Braille Communication Device

(71) Applicant: Stephen Sophorn Lim, Desert Hot Springs, CA (US)

(72) Inventor: Stephen Sophorn Lim, Desert Hot Springs, CA (US)

(21) Appl. No.: 17/827,294

(22) Filed: May 27, 2022

(51) Int. Cl. G09B 21/00; G09B 21/02; G06F 3/02; G06F 3/01

(52) U.S. Cl. CPC G09B 21/002; G09B 21/02; G06F 3/0219; G06F 3/014

(57) ABSTRACT

The Alternative Braille Communication Device is an improvement of the Braille Dot Delivery System, U.S. Pat. No. 10,380,915 B2 and Touch Sense Display For The Visually Impaired, Publication No.: US-2012-0295232-A1 to accommodate convenience to the user, and other valuable features; comprises of the main Receiver/Transmitter ePulse Emitter [300] that straps to the wrist of the user or where ever applicable and the Left Handed Keypad [350] and Right Handed Keypad [360] that straps to the forearm of the use or where ever applicable. With the Receiver/Tranmitter ePulse Keypad [350] containing a Removable One-Piece Gel Sheet that is disposable after an amount of usage and the keypad that contain a two-row keys for a one hand use alternating from the top row to the bottom row, and vise versa.

### BACKGROUND OF THE INVENTION—FIELD OF INVENTION

The Alternative Braille Communication Device [ABCD] is an improvement design from the Braille Dot Delivery System of U.S. Pat. No. 10,380,915 B2 issued on Aug. 13, 2019 and the Touch Sense Display For The Visually Impaired, Publication No.: US-2012-0295232-A1. Revisiting the technology of the Braille Dot Delivery System [BDDS], the device implements an electrical pulse to portray Braille dot resemblance, a language of physical sensing for communication. Designed for the visually impaired, the ABCD is versatile to create other language prospects for communication within other industries. The approach of delivering an electrical signal to each of the 6 electrodes in a 3×2 matrix to each dot position in different configurations; there creates its own and/or secret communication characters.

### BACKGROUND OF THE INVENTION—DESCRIPTION OF PRIOR INVENTION

Prior to the Braille Dot Delivery System, the Braille Touch Sense Display For The Visually Impaired was published to reveal the implementation of the electric pulse to generate a Braille dot resemblance of the Braille language. Where the method of communication was physical interaction instead of sight and sound was to have the finger touch the surface of the device to receive communications between users; with others associated communication technologies and/or peripheral connections to associate with the World Wide Web. Characters are input using a Braille keypad; where the Touch Sense Display For The Visually Impaired device are an attachment with the reading device and the Braille Dot Delivery System is a separate strap on keypad. With the dot delivery system device, the approaches for delivering phrases and/or sentences are programmed to sequences electrical signal to the users.

Implementing the electrical pulse to resemble the Braille dot eliminates the use of actuators, mechanical parts, solenoids and/or electromechanical components like the design of Robert C. Petersen of U.S. Pat. No. 4,871,992, which credit is given to Petersen for his unique and creative at about his time. Details components of Petersen idea of using a peg like to resemble the Braille, implements a helical spiral that spins to maneuver the peg to move up and down is an example of one Braille dot to protrude. To form letter, numbers, or characters, it requires 6 dots, to protrude or not, which character development require six individual mechanical components; the weight of the communication device could be enormous for everyday users to carry around.

The first revelation of the electrical pulse usage to resemble a Braille dot in lieu of the protruding or embossed dots is from the publication of the Braille Touch Sense Display For The Visually Impaired. The Touch Sense device designed reduces the big and bulkiness from the existing market product at the time. The Touch Sense device eliminates the use of mechanical components such as actuators and solenoids that most Braille communication devices uses but is still big and bulky to carry around for everyday use as the initial design using the electrical pulse technology. The next development lead to the second design called the Braille Dot Delivery System, where the design allows for adhering to the body parts by strap and harness to the device to read and input the Braille language characters. An ideal design for strapping the BDDS to a body parts but harnessing the device about the lower palm area of the hand could be cumbersome to the users; therefore, the third design to implement the electrical pulse technology is the Alternative Braille Communication Device, which the receiver/transmitter is place at about the wrist of the user, with ergonomic design to better comfort user was observed.

### BACKGROUND OF THE INVENTION—OBJECTS AND ADVANTAGES

In the Braille Dot Delivery System, the device that delivers the signal is place about the lower area of the palm; which discomfort for everyday usage could be cumbersome due to the harness that the users adhere to the palm area of the palm for delivering and receiving the physical sensing communication. A new improvement made to the Alternative Braille Communication Device is for the device to be worn at the wrist or where ever applicable of the user with an easy strap harness, in either side of the hand. A much easier to use is the elastic straps like that of a watch, the new design contains a removable and disposable one-piece gel pad that is gripped by each side or end of a sliding pad of the ABCD transmitter/receiver device. The disposable one-piece gel sheet could be a commercial application for ongoing business generation affairs. The Alternative Braille Communication Device has a new two rows keys keypad that can be type with one hand moving from the lower row of keys to the higher row of keys, and vise versa.

### SUMMARY OF THE INVENTION

The Alternative Braille Communication Device is a further design enhancement of the previous Braille Dot Delivery System, U.S. Pat. No. 10,380,915 B2 and the Touch Sense Display For The Visually Impaired, Publication No.: US-2012-0295232-A1 to allow for better application usage. The ABCD implements the same electrical pulse technology that eliminates mechanical components just like the previous generation design of the Braille Dot Delivery System and Touch Sense Display For The Visually Impaired, which derives many new features and design structures thereafter, like orientation of newly receiver/transmitter device application to strap to the wrist, and with newly designed keypads configuration that straps to the forearm or where ever applicable. The design allows for smaller and slimmer design of the keypads, with users of left-handed or right-handed. The technology benefit everyday visually impaired user and as well as others for its variety of language development capabilities. A communication device that can change language characters when the electrical pulse of each cells rearrange it signals, ideal for secret communications, from sectors like large private or public corporations to government, large or small. The main component is the electrical pulse transmitter/receiver that contain a removable and disposable gel sheet to minimize the ware and tare that could disrupt communication of everyday use. The disposable one-piece gel sheet could be a commercialized that could creates ongoing business affairs, observing from the economic side for the ABCD device.

Changes made to the Alternative Braille Communication Device are the receiver/transmitter electronic pulse emitter and a two-row keys keypad. The receiver/transmitter for both the touch sense that is worn about the wrist of the user and the two-row keys keypads are a newly designed that harness about the forearm areas or anywhere applicable that receives and delivers communication about the user body. The two-row keys keypad is designed with new buttons configurations for easy access using one hand for typing and inputting communication characters, swapping from the upper row to bottom row, vise versa. The keypad is much smaller and thinner, and made separately for left-handed or right-handed users.

A method of sense by touch communication delivers a resemblance of the Braille dot with nominal size sensation about the human flesh. Keeping the device features abreast of current technology, the Alternative Braille Communication Device may contains wireless capabilities between the transmitter and receiver via wireless technology like the wireless Bluetooth but not limited should better wireless technology are presents. The wireless technology avoids dangling wires connected from the keypads to the electrical pulse receiver, making life better for the disable world and others. The same structure design and application like that of the BDDS but with a little larger surface area for delivering the sense touch communication, when placed flushed to the skin. The 6 nominal size electrodes arranged in a 3×2 matrix is to stay align with the majority popular visually impaired language, the Braille. The scroll-like sequencing of the electrical impulse delivers the Braille dot resemblance.

Similar to the Braille Dot Delivery System, the Alternative Braille Communication Device is designed for compatibility with other smart devices like smart phones, computer, tables, and other communication devices; connect to the World Wide Web with many peripheral devices capabilities and others. With this capability, the ABCD and BDDS are not just a Braille device for the visually impaired but an application that can be used in all sector industries, from public, private, government, that a secret communication can be created with the repositioning of the electrode placement, all due to programming of the device.

### BRIEF DESCRIPTION OF THE DRAWINGS

The following is a brief description of the illustration drawings with components assemblies and applications of the Alternative Braille Communication Device that comprises of the receiver/transmitter sensor device and two row keys keypads:

FIG. 1 illustrates an exploded three-dimensional view of the receiver/transmitter electric pulse emitter and strap band with the cover separated to show the interior of the Alternative Braille Communication Device. The internal batteries with terminal connectors are placed in each corner cavities of the case.

FIG. 2 illustration details the case cavity, with components comprised of the batteries, terminal connections, and various slots holes for input and output, indicators and communication ports.

FIG. 3 illustrates the case cover, which components comprised of a removable one-piece gel sheet that rest between the two gel sheet slide covers at each end motioning along the cover; the slide cover lock and pin that motion vertically along the edge of the gel sheet slide covers.

FIG. 3A is a detailed illustration of the gel sheet slide cover with the slide cover lock and pin for securing the removable one-piece gel sheet when installed.

FIG. 4 illustrates an exploded view of the backside of the case cover, receiver/transmitter, which components comprised of the circuit board containing the connectors, the positive position for each cell wirings, negative position cell wiring, and the positive and negative pins that inserts into each cells for connection to the removable one-piece gel sheet.

FIG. 5 is an exploded view of the removable one-piece gel sheet components, which comprises of the positive and negative pins that fits into the hole of each electrode insert, the negative and positive electrode pad, and gel pads placed on top of each electrode inserts for the electrical pulse transfer medium between the human skin for signal communication.

FIG. 6 illustrates a left-handed for typing of a two-row keys keypad with communication ports and support straps, designed for typing with one hand moving from the top row to bottom row and vise versa.

FIG. 7 is an application illustration of the receiver/transmitter senor of the Alternative Braille Communication Device strapped to the wrist of the user.

FIG. 7A is an application illustration of the two-row keys keypad, for left handed users; shows fingers positioned at the top row of keys.

FIG. 7B is an application illustration of the two-row keys keypad, for left handed users, shows fingers positioned at the bottom row of keys.

FIGS. 8 and 9 are illustrations of the Alternative Braille Communication Device; receiver/transmitter sensors and the two-row keys keypad for the right handed users in three-dimensional colored.

DRAWINGS - Reference Numerals

| | | | |
|---|---|---|---|
| 300 | Receiver/Transmitter ePulse | 310 | Battery |
| | Emitter | | |
| 312 | Position Battery Terminal | 314 | Negative Battery Terminal |
| 316 | Indicator Lights | 318 | Slide Cover Hole |
| 320 | ePulse USB Port | 322 | ePulse Power Button |
| 324 | EPulse Headphone Port | 325 | ePulse Support Strap |
| 326 | Gel Sheet Slide Cover | 327 | Slide Cover Lock |
| 328 | Slider Cover Pin | | |
| 330 | ePulse Cover | 331 | Circuit Board |
| 332 | Pos Cover Pin | 333 | Neg Cover Pin |
| 334 | Neg Cover Pin Insert | 335 | Pos Cover Pin Insert |
| 336 | Pos Position Connectors | 337 | Neg Position Connector |
| 338 | Pos Position Cell Wirings | 339 | Neg Position Wiring |
| 340 | Removable One-Piece Gel | 341 | Electrode Inserts |
| | Sheet | | |
| 342 | Positive Pin Insert | 343 | Negative Pin Insert |
| 344 | Positive Pin | 345 | Negative Pin |
| 346 | Positive Electrode Pad | 347 | Negative Electrode Pad |
| 348 | Gel Pads | | |
| 350 | Left Handed Keypad | 351 | Upper Level Space Bar |
| 352 | Upper Row Key Buttons | 353 | Lower Level Space Bar |
| 354 | Lower Row Key Buttons | 355 | Keypad USB Port |
| 356 | Keypad Headphone Outlet | 357 | Keypad Indicator Lights |
| 358 | Keypad Support Straps | 359 | Keypad Power Button |
| 360 | Right Handed Keypad | | |

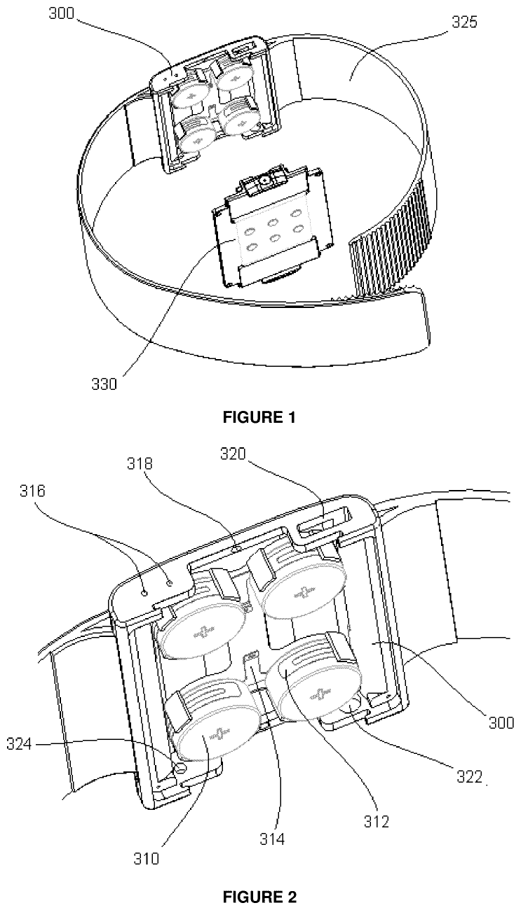

### DETAILED DESCRIPTION OF THE INVENTION—FIG. 1—EMBODIMENT

An embodiment of illustrations in FIG. 1 derives an Alternative Braille Communication Device (ABCD), which main components comprises of a Receiver/Transmitter ePulse Emitter [300] exposing the internal parts and components of the power supply rechargeable battery system by method of USB, the ePulse Cover [330] consists of an input/output receiver and transmitter, and ePulse Support Strap [325] that links sensing communication between the user and interface peripherals of the ABCD.

### Detailed Description—FIGS. 2—Embodiment

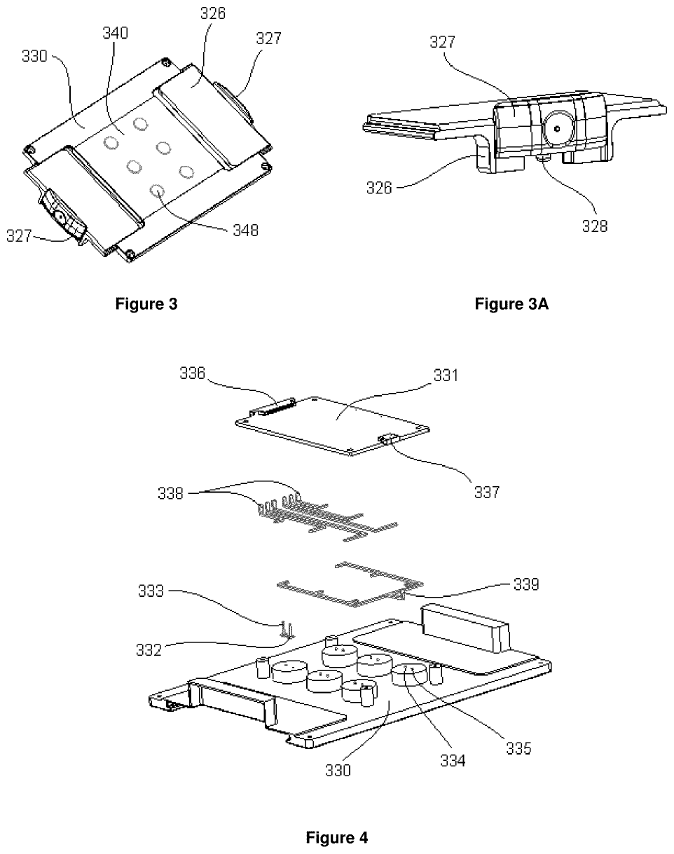

An embodiment in FIG. 2 derives a detailed assembled components of the Receiver/Transmitter ePulse Emitter [300], which parts and components comprises of Battery [310] placed in each corner cavity of the Receiver/Transmitter ePulse Emitter [300], harnessed by the Positive Battery Terminal [312] along the Battery [310] and the Negative Battery Terminal [314] place at the bottom. The exterior appearance comprises of communication ports with the ePulse Indicator Lights [316], the ePulse USB Port [320], the ePulse Power Button [322], and the ePulse Headphone Port [324] along with the Slide Cover Hole [318] for inserts of the Slide Cover Pin [328], which secures the Removable One-Piece Gel Sheet [340], detailed illustration in FIGS. 3 and 3A.

### Detailed Description—FIGS. 3 and 3A—Embodiment

An embodiment of the ePulse Cover [330] comprise of a Removable One-Piece Gel Sheet [340] with the Gel Pads [348] in a 3×2 matrix arrangement that is a medium transfer of an electrical pulse between the user's contact skin and the ABCD device surface; secured with a lateral movement Gel Sheet Slide Cover [326] and the re-enforcement Slide Cover Lock [327] that moves vertically to firmly secures the Removable One-Piece Gel Sheet [340].

A detailed embodiment of the Gel Sheet Slide Cover [326] of FIG. 3A details the attached Slide Cover [327] that motion vertically along the edge of the Gel Sheet Slide Cover [326] with the Slide Cover Pin [328] that inserts into the Slide Cover Hole [318].

### Detailed Description—FIG. 4—Embodiment

An embodiment of the ePulse Cover [330] details the back of the panel with electrical connections assembly, which components comprised of the Circuit Board [331] with the Pos Position Connectors [336] and Neg Position Connector [337] to connect to the Pos Position Cell Wirings [338], which allows electrical current for each position cells to resembled the Braille dot and the Neg Position Wiring [339] to complete the electrical connection loop. The Pos Cover Pin [332], along with the Neg Cover Pin [333] inserts into the Neg Cover Pin Insert [334] and Pos Cover Pin Insert [335] for continuity connections from the Removable One-Piece Gel Sheet [340].

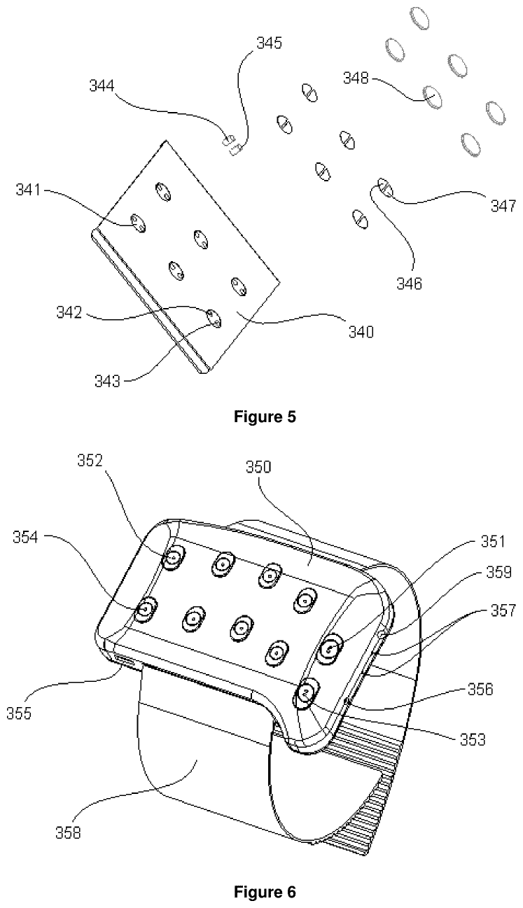

### Detailed Description—FIG. 5—Embodiment

An embodiment details the Removable One-Piece Gel Sheet [340] comprises in the order of the Electrode Inserts [341] to allow insertion of the Positive Pin [344] and Negative Pin [345], followed by the Positive Electrode Pad [346] and Negative Electrode Pad [347], completing the integral assembly with the Gel Pads [348] adheres to the top.

### Detailed Description—FIG. 6—Embodiment

An embodiment of the Left Handed Keypad [350] comprise of the Upper Level Space Bar [351] which function allows for typing at the top row keys that starts along the Upper Row Key Buttons [352]. The Lower Level Space Bar [353] row allows for typing with the low row keys that start with the Lower Row Key Buttons [354]. The peripheral accessories comprise of the USB port [350], Keypad Headphone Outlet [356]; along with the Keypad Indicator Lights [357], the Keypad Support Straps [358], and a Keypad Power Button [359] for the receiving and transmitting activities of the keypad.

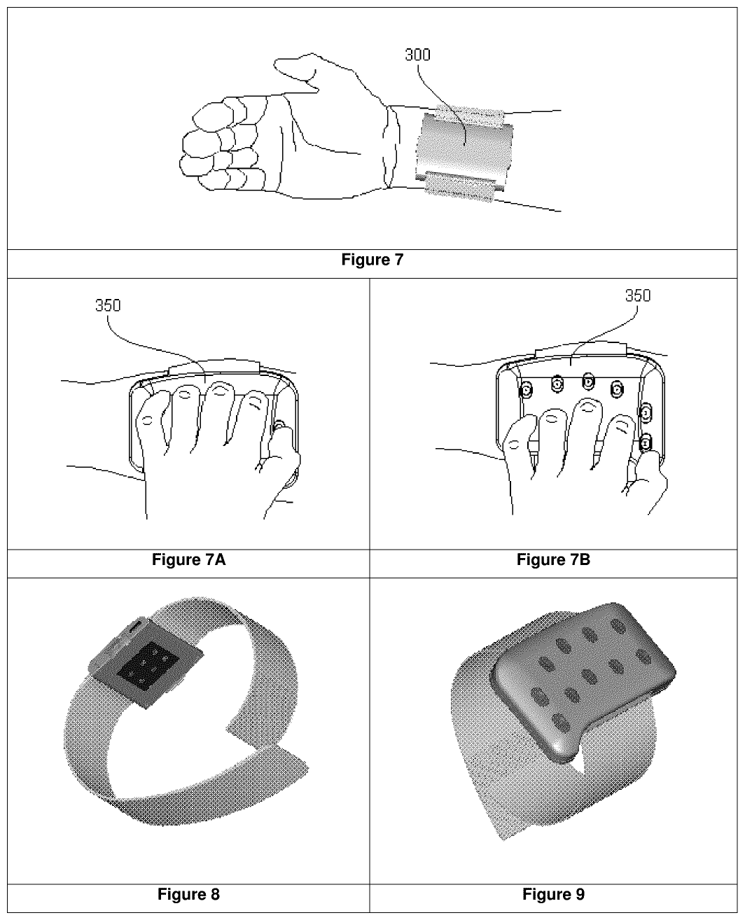

### Detailed Description—FIGS. 7, 7A and 7B—Embodiment

An embodiment of the Alternative Braille Communication Device comprise of Receiver/Transmitter ePulse Emitter [300] with support strapped application; a Left Handed Keypad [350] demonstrates the Upper Row Key Buttons [352] along with Upper Level Space Bar [351] and the Lower Row Key Buttons [354] along with the Lower Level Space Bar [353].

### Detailed Description—FIGS. 8 and 9—Embodiment

An embodiment of the Alternative Braille Communication Device comprise of the Receiver/Transmitter ePulse Emitter [300] in FIG. 8 and Right Handed Keypad [360] in FIG. 9.

### Operations—FIGS. 1, 2, 3-3A, 5, and 7-7B

The Alternative Braille Communication Device is composed of two separate devices; the main device is the Receiver/Transmitter ePulse Emitter [300] that receives data and converts into an electrical pulse of an established language of the Braille, which communicates with the use; and the input device, Left Handed Keypad [350] or the Right Handed Keypad {360], which keypads are developed to allow inputting characters along the top key rows and/or along the bottom key rows, illustrations in FIGS. 7 and 7B. A Removable One-Piece Gel Sheet [340] is the medium, when placed flushed onto the human skin, creates communication, a language of physical sensing. An additional application and feature is that the ABCD can create and programmed to contain its own language, which is ideal for other industries implementation beside the medical industry.

Observing the Receiver/Transmitter ePulse Emitter [300], a Removable One-Piece Gel Sheet [340] is a disposable piece that can be replace when clear communication is essential or after multiple uses. The approaches for removing the Removable One-Piece Gel Sheet [340] requires unlocking two of the Slide Cover Lock [327] panel vertically to free the Slide Cover Pin [328] from the Slide Cover Hole [318]. Thereafter, slide both of the Gel Sheet Slide Cover [326] normal to each other; and the Removable One-Piece Gel Sheet [340] could be removed and/or replaced. To implement communications with the Receiver/Transmitter ePulse Emitter [300], when the Removable One-Piece Gel Sheet [340] is installed, place the Receiver/Transmitter ePulse Emitter [300] onto the wrist portion of the arm, flushed where contacts are secured for the electrical pulse be delivered and secure the ePulse Support Strap [325].

Connected via wireless technology that exists nowadays, the Receiver/Transmitter ePulse Emitter [300] may receive and transmit signals with either the Left Handed Keypad [350] or the Right Handed Keypad [360]. Transmission from the Receiver/Transmitter ePulse Emitter [300] is for alert detections of the low battery of vibrations and/or sound options, analytic of the performance for maintences, and related information to keep the Receiver/Transmitter ePulse Emitter [300] to performance as it should. To input characters to Receiver/Transmitter ePulse Emitter [300], the two row keys of the either Left Handed Keypad [350] or Right Handed Keypad [360] can be inputted by typing the top row keys and/or the bottom row keys. Peripheral communication ports like that of USB, Micro USB port, Microphone, Headphone, Internet/WWW and AC/DC power supply port are contain with both the Receiver/Transmitter ePulse Emitter [300] and the either Left Handed Keypad [350] or Right Handed Keypad [360] and are not limited, when there exists other better peripheral communications accessories.

### CONCLUSION

The Alternative Braille Communication Device is a further design physical sensing device of the previous Braille Dot Delivery System and Touch Sense Device For The Visually Impaired that is not just a 3×2 Braille Dot Resemblance implementing electrical pulse but a communication device that can be develop to create new languages; a language that could be imperative when it comes to secrecy and protecting its entity of outside intruders. The communication device can protect entities of their trade secrets in the security protection sector of the public, private, government, and other related industries. With a new design and feature, the ABCD could be for commercialization of product for its disposable item that could be an ongoing production, in the area of business generating. The Alternative Braille Communication Devices comprises of two pieces, the Receiver/Transmitter ePulse Emitter that is worn at the wrist and a new keypad design with a two-row keys keypad for single hand operation, Left Handed Keypad [350] and Right Handed Keypad [360], or applicable to other wearable areas of the body.

In the language of secrecy, the Alternative Braille Communication Device can be implemented to create other languages besides Braille in the method of repositioning the dot electrical signal to a different position about the 3×2 dot matrix and the characters known are only of the creator repositioning the electrical pulse dot. An example to implement in the field for this application is say for a group of securities conducting an operation that requires only the group to know so when and where to call for the execution. In a corporate entity, a breach of data may lead to the security department to investigate with in the corporation, where only the elite security team can execute prosecutions by secret communication of this nature.

The Receiver/Transmitter ePulse Emitter [300] is the main piece to the Alternative Braille Communication Device, the physical sensing device that delivers the dot electrical pulse to use. When the device is attached flushed to the user's skin, signals of the Braille or other created language are transmitted. After many uses, the Removable One-Piece Gel Sheet [340] may need replacement; this item of application may be commercialized ongoing production of the product for business generating side, in addition to developing the communication device.

The Left Handed Keypad [350] or Right Handed Keypad [360] is the receiver/transmitter that creates the characters to the Receiver/Transmitter ePulse Emitter [300] to be transmitted via electrical pulse to the user's skin for communication, which is designed to contain two rows of keys. The two rows of keys allows for easy access typing, alternating the hand function from the top row keys to the bottom, and vise versa to create characters and/or words and/or sentences or phrases and others. Where creating word and phrases or sentences, the Receiver/Transmitter ePulse Emitter [300] would sequence it pulses to form.

Further observation may be essential to evaluate sensitivities on human skin with low frequency electrical pulse continuous contact usage. But an approach to reducing such problems is alternating using the device from one side of the wrist to the other, at this time. With further research and development, better approaches may be essential to deliver the best outcome usage and development of the Alternative Braille Communication Device product.

1. An Alternative Braille Communication Device is said comprises of an Receiver/Transmitter ePulse Emitter [300] that straps about the wrist of the user or any where applicable; along with a two-row keys keypad that straps about the forearm of the user or any where applicable, made for left handed or right handed user are the Left Handed Keypad [350] or Right Handed Keypad [360].

2. In accordance to claim 1, where said the Receiver/Transmitter ePulse Emitter contain a Removable One-Piece Gel Sheet that is disposable after many use; a prospect for commercial production along the business side.

3. In accordance to claim 1, where said a keypad for left-handed or right-handed user consist of a two-row keys for typing with one hand by typing along the top and/or bottom portion keys to create characters to be transmitted to the Receiver/Transmitter ePulse Emitter [300] to deliver electrical pulse characters to the users.

4. In accordance to claim 1, where said to derive other physical sensing communication language with the approach of repositioning electrical pulse signals from the 3×2 cell positions into other cell slots, is said to create a communication language aside from the popular Braille language.
